(19) United States
(12) Patent Application Publication
(10) Pub. No.: US 2009/0051187 A1
(43) Pub. Date: Feb. 26, 2009

(54) ROLLER-BLIND SYSTEM WITH DAMPENED FINAL POSITION

(76) Inventor: Peter Biecker, Oberhaching (DE)

Correspondence Address: DICKINSON WRIGHT PLLC, 1875 Eye Street, NW, Suite 1200, WASHINGTON, DC, 20006, US

(21) Appl. No.: 11/909,813

(22) PCT Filed: Mar. 29, 2006
(86) PCT No.: PCT/DE2006/000558

§ 371 Date: May 19, 2008

(30) Foreign Application Priority Data
Mar. 29, 2005 (DE) 10 2005 014 173.0

(51) Int. Cl. B60R 5/04; B60R 11/00; B60R 21/08

(52) U.S. Cl. 296/37.16; 160/296

(57) ABSTRACT

The invention relates to a roller-blind system especially for the trunk cover of a vehicle. Said roller-blind system comprises a roller-blind material which is wound onto a winding shaft (1) between a covering position and a stowed position. The system is provided with a damping mechanism (2) which retracts the roller-blind material into the stowed position at the end of a winding process in a defined, decelerated manner. The damping mechanism (2) is adapted to reduce the rotational speed of the winding shaft (1) and to bring the rotation of the winding shaft (1) to a standstill within a predetermined rotational angle of the winding shaft (1).

The invention relates to a roller-blind system, in particular a trunk covering for the trunk of a vehicle, with a roller-blind material which can be wound up on a winding shaft between a covering position and a stowed position, wherein a damping means is provided which serves for the defined, speed-reduced retraction of the roller-blind material into the stowed position at the end of a winding-up operation.

Such a roller-blind system of the type in question is known, for example, from DE 102 42 173 A1. The roller-blind system described there is provided for use for a rear window of a motor vehicle and has at least one pivoting arm which serves to clamp the roller blind and is coupled at one end in the region of the winding shaft. The other end of the pivoting arm is forcibly guided as a shiftable pivot point which, after a predeterminable shifting distance during the transition from a pivoting-arm clamping position into a pivoting-arm basic position, can be supported by a damping element which is preferably designed as a spring element. The roller-blind system permits a defined and speed-reduced retraction of the roller blind into the roller-blind stowed position at the end of the winding-up operation. This property is achieved merely by the provision of the spring element without the use of an electric control device. Since said spring element which acts as a damping element only acts within a restricted range, i.e. in a predeterminable, final subsection of the shifting displacement of the shiftable pivot point, the roller blind can be rapidly and continuously rolled up at the beginning of the winding-up operation via a driving motor coupled to the winding shaft, and a speed reduction by the action of the spring force as a damping means can permit the final roller-blind subregion to be retracted at the desired reduced speed only in a final subsection critical with regard to a retraction operation.

In this configuration, the damping element is designed as a compression spring, with the speed reduction being predeterminable individually and as desired as a function of the driving motor and/or the spring rate and/or the effective length of the spring upon compression.

This system has the disadvantage that the roller-blind material can be wound up and unwound only with the use of a driving motor which can keep the roller-blind system in its stowed position counter to the force of the spring element. Furthermore, during the unwinding of the roller-blind material from the winding shaft, the spring element brings about a speed-increased unwinding at the beginning of the unwinding operation, which may possibly be undesirable. Furthermore, the roller-blind system requires a linkage in the form of at least one pivoting arm between the winding shaft and a pull rod arranged at the free end of the roller blind, which makes the roller-blind system inflexible and therefore impractical for use as a trunk covering.

It is therefore the object of the present invention to indicate a roller-blind system, in particular a trunk covering for the trunk of a vehicle, with which improved, speed-reduced retraction of the roller blind at the end of the winding-up operation is possible.

This object is achieved by means of a roller-blind system having the features of patent claim 1. Advantageous refinements emerge from the dependent patent claims.

The basic concept of the present invention is to influence the speed reduction of the roller-blind material during the winding-up operation by directly influencing the rotational speed of the winding shaft, thus resulting in a mechanically particularly simple construction of the roller-blind system. In particular, it is possible for a spring to drive the winding-up operation of the roller-blind material which can be wound up on a winding shaft between a covering position and a stowed position. A structurally simple and cost-effective arrangement can therefore be provided.

In the case of the roller-blind system according to the invention, in particular trunk covering for the trunk of a vehicle, with a roller-blind material which can be wound up on a winding shaft between a covering position and a stowed position, a damping means is provided which serves for the defined, speed-reduced retraction of the roller-blind material into the stowed position at the end of a winding-up operation. According to the invention, the damping means is designed in order to reduce the rotational speed of the winding shaft and to bring the rotation of the winding shaft to a standstill within a predetermined angle of rotation of the winding shaft.

The damping means according to the invention is distinguished in that the distance which is covered by the roller-blind material and within which a damping, i.e. a defined speed reduction, is to take place, can be set freely and as desired. The damping distance during the retraction of the roller-blind material from the covering position into the stowed position is therefore dependent on the angle of rotation set for the winding shaft and within which damping takes place. The angle of rotation may be smaller than 360° with the damping taking place at less than one rotation of the winding shaft. However, the angle of rotation may also comprise a plurality of full revolutions of the winding shaft.

In one refinement, the damping means is a torsional viscous damper which is arranged in the winding shaft and comprises a first component and a second component which is rotatable toward the first component, the first component, which is secured against rotation, being fastened to a bodywork component and the second component being able to be brought into operative connection with the winding shaft in order to transmit a torque. The use of a torsional viscous damper permits a particularly space-saving arrangement, since all of the mechanical components necessary for the damping to be obtained can be arranged within the winding shaft. Furthermore, a torsional viscous damper has the advantage of an operative connection to components outside the winding shaft, for example a linkage which extends in the surface region of the roller-blind system, being unnecessary.

In one development, it is provided that the operative connection between the winding shaft and the second component of the torsional viscous damper can be produced by an end piece, which is connected in a rotationally fixed manner to the winding shaft, and a number of control disks which are rotatable in relation to the winding shaft. A torque is exerted on the damping means by the end piece which is connected in a rotationally fixed manner to the winding shaft. The moment at which the torque is transmitted to the damping means depends on the number of control disks which are rotatable in relation to the winding shaft. Each control disk causes a delay of the transmission of the torque from the end piece, which is connected to the winding shaft, to the damping means. The fewer the number of control disks arranged between the end piece and the damping means, the sooner damping takes place, starting from the covering position, during the retraction of the roller-blind material. Conversely, if a greater number of control disks are provided, damping only takes place at the end of a winding-up operation.

The control disks are preferably arranged in the interior of the winding shaft.

In order to transmit the torque exerted by the winding shaft, each of the control disks has, on its opposite sides, lugs which are designed in order to transmit the torque to the lug of the next control disk in each case.

In this case, the lugs are preferably in the form of a sector of a circle with a given lug angle such that, during a transmission of torque, a planar contact is produced between the lug of a control disk and the lug of the next control disk in each case. This ensures that even high torques can be reliably transmitted to the damping means via the respective control disks.

It is furthermore provided that the number of control disks and the design of the lugs, in particular of the lug angles of the lugs which are in the shape of a sector of a circle, are dependent on the desired distance to be damped during the retraction of the roller-blind material from the covering position into the stowed position at the end of an unwinding operation. By means of a suitable selection of the number of control disks in conjunction with the design of the lugs, it can therefore be defined after how many revolutions of the winding shaft, starting from the covering position of the roller-blind material, the beginning of the damping is to take place.

The smaller the lug angle, the greater is the angle of revolution of the winding shaft until torque is transmitted from a control disk to the next control disk in each case. In addition to the setting of the damping distance and the damping length, the size of the lug angle is also dimensioned in accordance with stability criteria such that torque can be transmitted from the winding shaft to the damping means without the risk of damaging a lug.

A further refinement provides that the second component of the torsional viscous damper has a lug which is rotatable between a starting position and an end position and, when rotated, brings about a damping of the rotation of the winding shaft, with rotation from the starting position to the end position taking place by means of engagement with a lug of one of the control disks. The definition of the starting position and the end position enables the angle of rotation of the winding shaft, within which damping takes place until the winding shaft is at a complete standstill, to be defined. The second component of the torsional viscous damper can be interpreted as a control disk which, by means of rotation in relation to the first component, experiences damping until the winding shaft is at a complete standstill.

In a further refinement, a resetting means is provided which sets the damping means into a starting state when the roller-blind material is brought from its stowed position into the covering position, and therefore, during the next retraction of the roller-blind material from the covering position into the stowed position, the defined speed reduction is provided. The resetting means therefore opposes the damping, which occurs during the winding-up operation, within a defined region. However, the force of the resetting means is not sufficient in order to prevent the in particular spring-driven winding-up of the roller-blind material onto the winding shaft. However, if the roller-blind material is brought again from its stowed position into its covering position—whether mechanically or by electric motor—then the resetting means ensures that the damping means is set back into a defined starting state such that, during each winding-up operation of the roller-blind material, the damping takes place at the predetermined moment and/or for a predetermined distance.

In this case, it is advantageous if the resetting means brings the second component of the torsional viscous damper from the end position into the starting position when the roller-blind material is brought from its stowed position into the covering position. The resetting means is therefore in operative connection with the second component of the torsional viscous damper and rotates said component back into its starting position. This takes place in a particularly simple manner by the resetting means being designed as a leg spring which is arranged concentrically with respect to the damping means and surrounds the first component of the torsional viscous damper, which component is mounted in a rotationally fixed manner.

In a further refinement, it is furthermore provided that the resetting means exerts a prestressing force on the second component of the torsional viscous damper when the second component is in its starting position. The prestressing ensures that the resetting means can also bring the damping means into its starting position counter to the damping acting in the resetting direction.

The invention is explained in more detail below with reference to an exemplary embodiment. In the drawing:

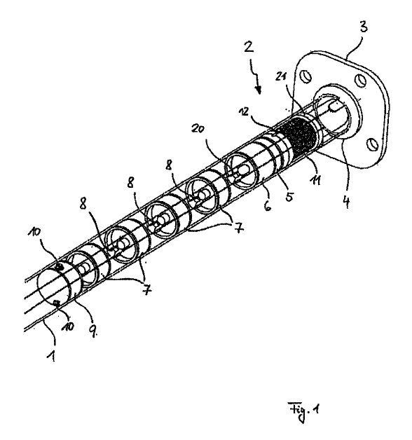

FIG. 1 shows a perspective illustration of a winding shaft in which a damping mechanism according to the invention is arranged,

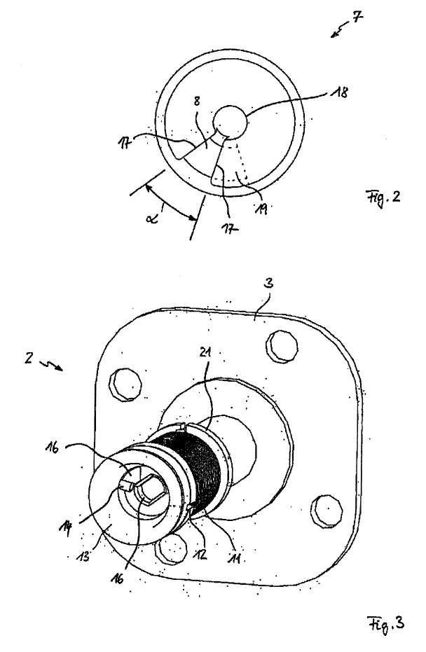

FIG. 2 shows a top view of a control disk of the damping mechanism,

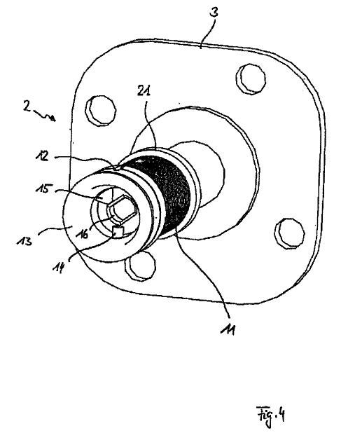

FIG. 3 shows a perspective view of the damping means used in the invention in a starting state, and

FIG. 4 shows a perspective view of the damping means used in the invention in an operating state which brings about damping.

Identical features are provided with the same reference numbers in the figures below.

FIG. 1 illustrates, in a perspective view, the components of a roller-blind system that are necessary for the defined, speed-reduced retraction of a roller-blind material (not illustrated in the figure) into a stowed position at the end of a winding-up operation. Although it is not apparent from the figure, a roller-blind system can be arranged in a known manner between a covering position and a stowed position by the roller-blind material being wound up on a winding shaft 1. The roller-blind system in particular forms a trunk covering for the trunk of a vehicle. However, the roller-blind system may also be used in any other desired areas of use, such as, for example, as a roller-blind system for a window pane of a vehicle or for a window.

According to the exemplary embodiment of the invention, the roller-blind system is preferably wound up with the use of a spring drive (not illustrated) which can be arranged in a known manner in the interior of a winding shaft 1. The unrolling of the roller-blind material from the winding shaft 1, i.e. from its stowed position into the covering position, can take place manually by means of a user of the roller-blind system or by means of electric motor.

FIG. 1 illustrates the components necessary for the defined, speed-reduced retraction of the roller-blind material into its stowed position at the end of the winding-up operation. The winding shaft 1 is connected rotatably via a rotary bearing 4 to a fastening element 3 which is to be fastened to a bodywork component. An end piece 9 is arranged within the winding shaft 1 and is connected to the winding shaft 1 in a rotationally fixed manner by means of a fastening element 10, for example a screw or a pin. A torsional viscous damper serving as the damping means 2 is arranged in an end region of the winding shaft 1 in the vicinity of the fastening element 3 which is fixed to the bodywork.

A number of control disks 7 is provided between the end piece 9 and the torsional viscous damper 2. Each of the control disks 7 has, on its front and rear side, a lug 8 which is designed in the shape of a sector of a circle. FIG. 2 shows the top view of a front side of a control disk 7 of this type. The lug 8 has a lug angle α and two opposite sector surfaces 17. An identically designed lug 19 is provided on the rear side of the control disk 7.

The lug 19 can in principle be arranged at any desired location on the rear side of the control disk 7. Since the control disk 7 is preferably composed of a plastic produced by means of injection molding, it is advantageous to arrange the lugs 8, 19 which are arranged on the front and rear sides, not such that they are opposite each other but, as shown in FIG. 2, such that they are offset with respect to each other so as to avoid accumulations of material. The control disk 7 is held in the winding shaft 1 in a manner such that it can rotate about an axis of rotation 18.

Contrary to the graphical illustration, the control disks 7 are not spaced apart from one another in the manner shown in FIG. 1, but rather are directly adjacent such that respective sector surfaces 17 of a lug arranged on the front side can be brought into engagement with a sector surface of a lug arranged on the rear side of the adjacent control disk. Although it cannot be seen in FIG. 1 either, the end piece 9, which is connected in a rotationally fixed manner to the winding shaft 1, has a correspondingly shaped lug on the side facing the first control disk 7.

A lug 20 formed in a manner corresponding to the previously described lugs 8 of the control disk 7 is formed on a housing part 6 of the torsional viscous damper 2, which housing part is connected fixedly to a housing part 5. The housing part 6 and the housing part 5, which may also be formed integrally, are rotatable in relation to a further component (not visible in the figure) of the torsional viscous damper 2, with said component being connected in a rotationally fixed manner to the fastening element 3 and therefore to the bodywork component. A rotation, produced by application of a torque, of the housing part 6 in relation to the non-rotatable component of the torsional viscous damper produces the desired damping.

When the roller-blind material is wound up from a covering position into its stowed position, torque is transmitted from the end piece 9, more precisely from the lug (not visible) formed thereon, via the number of inserted control disks 7 to the housing part 6. The torque is transmitted by a respective control disk, i.e. more precisely a respective lug, to the lug of the next control disk 7 in each case. The effect achieved by the shaping of the lug, in particular by the dimensioning of the lug angle α, is that torque is transmitted only after an angle of rotation of 360°-α of the lug. During the spring-driven winding-up of the roller-blind material, all of the control disks 7 are therefore brought successively into engagement and only in an end region of the winding-up of the roller blind is a torque-locking connection to the torsional viscous damper 2, i.e. the housing part 6, produced. By rotation of the housing part 6, owing to the torque exerted by the lug 20, in relation to the component of the torsional viscous damper that is mounted in a rotationally fixed manner, damping takes place and therefore the rotational speed of the winding shaft is reduced within a predetermined angle of rotation until the winding shaft is at a standstill.

The damping therefore takes place by rotation of the housing parts 5, 6 in relation to the other component of the torsional viscous damper, which component is placed in the interior concentrically with respect to said components.

The number of control disks 7 and the size of the lug angle α of the lugs 8, 19 define how many revolutions the winding shaft 1 covers without damping until it enters into engagement with the torsional viscous damper 2. The greater the number of control disks 7 and/or the smaller the lug angle α of the lugs 8, 19, the greater is the number of revolutions of the winding shaft without damping and therefore the distance covered by the roller-blind material between its covering position and its stowed position without damping. An adaptive arrangement to various trunk depths or to various damping distances can therefore be undertaken by means of suitable selection of the number of the control disks and the dimensioning of the lug angles α.

In the variant shown in FIG. 1, damping is provided within an angle of less than 360°, thus resulting in practice in a damping distance of up to 10 cm. In order to increase the damping distance, there is the possibility of also undertaking the damping over a plurality of revolutions of the winding shaft 1, by control disks designed in accordance with the above description being provided in the torsional viscous damper between the component 13 bearing the projection 14 and the component having the stop 16.

FIG. 3 illustrates an enlarged cutout of a part of the arrangement used for the damping, wherein the torsional viscous damper, or more precisely the housing parts 5, 6 thereof and the non-rotatable component cannot be seen. The figure shows a housing part 13 on which a projection 14, which is merely pin-shaped by way of example, is arranged. The housing part 13 and the projection 14 can be manufactured as a single piece, for example from a plastic. The housing part 13 is connected in a form-fitting manner to the rotatable part of the torsional viscous damper (housing parts 5, 6). The non-rotatable part of the torsional viscous damper is mounted in the receptacle 16, which is designed as an elongated hole, in a rotationally fixed manner in relation to the fastening element 3 and therefore in relation to the bodywork component of the vehicle. A stop 15 is furthermore connected, such that it is fixed to the bodywork, to the component forming the receptacle 16. In the position illustrated in the figure, the system is in its starting position, with the component 13 being pressed against the stop 15 by means of a prestressing of a leg spring supported in a groove 12 of this housing part 13 and a groove 22 of a rotationally fixed housing part 21.

If the housing of the torsional viscous damper is subjected to a torque owing to a spring-driven winding-up of the roller-blind material and therefore a rotation of the winding shaft, the housing part 13 with the lug integrally formed thereon rotates in the counterclockwise direction counter to the stressing of the leg spring 11 into the operating position shown in FIG. 4. The latter could constitute, for example, the end position in which the roller-blind material has entirely reached its stowed position. The end position could also be formed by the housing part 13 with the projection 14 fastened thereto being brought into contact against the other surface of the stop 15.

Damping of the rotation takes place by means of the rotation of the housing part 13 away from the stop 15 in the counterclockwise direction counter to the prestressing moment of the leg spring 11. In the illustration shown in FIG. 4, the leg spring 11 is therefore loaded by a spring moment which is used to reset the torsional viscous damper.

When the roller-blind material is unwound from its stowed position in the direction of its covering position, the transmission of force between the winding shaft and the torsional viscous damper ends, as a result of which force is no longer exerted on the housing part 13 either. Owing to its spring moment, the leg spring 11 rotates the housing part 13 from the position shown in FIG. 4 back into the starting position shown in FIG. 3. This ensures that, during the next winding-up operation of the roller-blind material, the damping and reduction in speed during the winding-up at the end of a winding-up operation can take place in a manner identical to that previously described.

In principle, it is sufficient to provide the damping device described at one end of the winding shaft, as a result of which the spring drive for winding up the roller-blind material can be provided at the other end of the winding shaft. If the winding up takes place in a different manner structurally, the damping means may also be provided at both ends of the winding shaft. By this means, in particular a stepped damping is conceivable, in which first of all a winding-up operation can take place without damping, a further winding-up operation can take place with a first damping and, finally, a winding-up operation can take place with a second stronger damping. This can take place, for example, by means of the provision of a different number of control disks in the two damping means.

### List of Designations

1 Winding shaft
2 Damping means
3 Fastening element
4 Rotary bearing
5 Housing part
6 Housing part
7 Control disk
8 Lug
9 End piece
10 Fastening element
11 Leg spring
12 Groove
13 Housing part
14 Projection
15 Stop
16 Receptacle
17 Sector surface
18 Axis of rotation
19 Lug
20 Lug
21 Housing part
22 Groove α Angle

1. A roller-blind system, in particular trunk covering for the trunk of a vehicle, with a roller-blind material which can be wound up on a winding shaft between a covering position and a stowed position, wherein a damping means is provided which serves for the defined, speed-reduced retraction of the roller-blind material into the stowed position at the end of a winding-up operation, characterized in that the damping means is designed in order to reduce the rotational speed of the winding shaft and to bring the rotation of the winding shaft to a standstill within a predetermined angle of rotation of the winding shaft.

2. The roller-blind system of claim 1, characterized in that the damping means is a torsional viscous damper which is arranged in the winding shaft and comprises a first component and a second component which is rotatable toward the first component, the first component, which is secured against rotation, being fastened to a bodywork component and the second component being able to be brought into operative connection with the winding shaft in order to transmit a torque.

3. The roller-blind system of claim 1, characterized in that the operative connection between the winding shaft and the second component can be produced by an end piece, which is connected in a rotationally fixed manner to the winding shaft, and a number of control disks which are rotatable in relation to the winding shaft.

4. The roller-blind system of claim 3, characterized in that each of the control disks has, on its opposite sides, lugs which are designed in order to transmit a torque to the lug of the next control disk in each case.

5. The roller-blind system of claim 4, characterized in that the lugs are in the form of a sector of a circle with a lug angle such that, during a transmission of torque, a planar contact is produced between the lug of a control disk and the lug of the next control disk in each case.

6. The roller-blind system of claim 3, characterized in that the number of control disks and the design of the lugs, in particular of the lug angles of the lugs which are in the shape of a sector of a circle, are dependent on the desired distance to be damped during the retraction of the roller-blind material from the covering position into the stowed position at the end of a winding-up operation.

7. The roller-blind system of claim 3, characterized in that the second component of the torsional viscous damper has a lug which is rotatable between a starting position and an end position and, when rotated, brings about a damping of the rotation of the winding shaft, with rotation from the starting position to the end position taking place by means of engagement with a lug of one of the control disks.

8. The roller-blind system of claim 1, characterized in that a resetting means is provided which sets the damping means into a starting state when the roller-blind material is brought from its stowed position into the covering position, and therefore, during the next retraction of the roller-blind material from the covering position into the stowed position, the defined speed reduction is provided.

9. The roller-blind system of claim 8, characterized in that the resetting means brings the second component of the torsional viscous damper from the end position into the starting position when the roller-blind material is brought from its stowed position into the covering position.

10. The roller-blind system of claim 8, characterized in that the resetting means is designed as a leg spring which is arranged concentrically with respect to the damping means and surrounds the first component of the torsional viscous damper.

11. The roller-blind system of claim 9, characterized in that the resetting means exerts a prestressing force on the second component of the torsional viscous damper when the second component is in the starting position.
